(19) United States
(12) Patent Application Publication
(10) Pub. No.: US 2008/0167768 A1
(43) Pub. Date: Jul. 10, 2008

(54) CONTROL SYSTEM FOR A VESSEL WITH A GYROSTABILIZATION SYSTEM

(75) Inventors: David S. Rubenstein, Falmouth, ME (US); Richard H. Akers, Portland, ME (US)

Correspondence Address: CHRIS A. CASEIRO, VERRILL DANA, LLP, ONE PORTLAND SQUARE, PORTLAND, ME, 04112-0586, US

(73) Assignee: Marine Motion Control, LLC, Portland, ME (US)

(21) Appl. No.: 11/775,188

(22) Filed: Jul. 9, 2007

Related U.S. Application Data
(63) Continuation-in-part of application No. 10/958,562, filed on Oct. 4, 2004, now Pat. No. 7,240,630.
(60) Provisional application No. 60/509,653, filed on Oct. 8, 2003.

(51) Int. Cl. G05D 1/08

(52) U.S. Cl. 701/21

(57) ABSTRACT

A control system architecture and algorithm to manage a gyrostabilization system for a marine craft. The control system may manage other effectors in addition to the gyrostabilization system. The objective of the control system software is to utilize any and all available control authority so as to bring about the desired change in the vessel's dynamic state. This control authority is produced by the gyrostabilization system or a combination of the gyrostabilization system with a number of other potential actuation systems or effectors. The focus of the gyrostabilizer control portion is the control and stabilization of the vessel's roll axis in particular

### CROSS REFERENCE TO RELATED APPLICATION

The present application is a continuation-in-part of, and claims priority benefit in, U.S. nonprovisional application Ser. No. 10/958,562, filed Oct. 4, 2004, entitled “GYROSTABILIZER FOR SMALL BOATS” in the name of co-inventor Richard H. Akers, which application claimed the priority benefit of U.S. provisional patent application Ser. No. 60/509,653, filed Oct. 8, 2003, entitled “GYROSTABILIZER FOR SMALL BOATS”. The entire contents of both applications are incorporated herein by reference.

### BACKGROUND OF THE INVENTION

1. Field of the Invention

The present invention relates to systems and devices for stabilizing boats and small ships. More particularly, the present invention relates to control systems for gyroscopic stabilizers and other types of stabilizers positioned in and/or on boats and configured to counteract rolling motion caused by waves and ship wakes.

2. Description of the Prior Art

A rolling boat is uncomfortable and can cause people and animals to experience motion sickness. A device that can create an anti-roll torque can be used to oppose this motion. The difficulty with creating such a device is that a boat is not resting on or in a solid medium that can be used as a base to create an anti-rolling moment. One solution to this problem is to use a large gyroscope to stabilize the boat. A gyroscope is a rotor spinning at a high speed around its spin axis, mounted in a frame that can be moved as the user wishes. When the spinning wheel is turned around an axis (gimbal axis) that is at right angles to its spin axis, a torque is generated around a third axis that is perpendicular to both the spin axis and the turning axis. A gyrostabilizer creates a torque or moment that reduces rolling motion. The gyrostabilizer has a rotor whose spin axis is nominally vertical. The rotor frame is mounted on gimbals so that the rotor can rotate about a transverse, side-to-side axis, but the frame is fastened to the vessel so that the system is constrained to roll from side to side with the boat. With proper selection of the spin and gimbal axes, a torque can be created to oppose roll motion.

Gyroscopic stabilizers (gyrostabilizers) were first used to stabilize very large ships and yachts almost a century ago, and their ability to resist rolling motion (side to side rotation) is well understood. In 1913, the Sperry Gyroscope Company installed a 5-ton gyrostabilizer on the USS Worden, a 700-ton destroyer. Although the device performed as expected, the Navy stopped installing gyrostabilizers at the onset of WW I. Some gyrostabilizers were installed on private yachts in the first part of the 20th century, but other methods of stabilization supplanted gyrostabilizers in the yacht market. Details regarding the important characteristics of a gyrostabilizer rotor are described in the referenced nonprovisional application.

When a gyroscope is turned around an axis, called the gimbal axis, which is approximately at right angles to its spin axis, it creates a torque around a third axis, orthogonal to the first two. To create an anti-rolling gyrostabilizer, the spin axis is nominally vertical, and the spinning rotor is tipped forward or backwards on a gimbal axis in the boat. The result is a torque orthogonal to both the spin axis and the gimbal axis. Nominally this torque is aligned with the boat's roll axis, and therefore can be utilized as an anti-rolling torque. The strength of this torque depends on the angle formed by the spin axis and the gimbal axis. Assuming that the boat rotation is primarily around its roll axis, and that rotation around the boat's pitch axis is small enough to be ignored, as the tip angle increases, the included angle decreases and the anti-rolling torque decreases. Accordingly, the maximum anti-rolling restoring torque will be limited to the based on maximum gimbal angles of plus or minus ninety-degrees.

Apart from the very large scale passive gyrostabilizer developed by Sperry for Navy vessels of World War I, systems designed to stabilize vessels usually rely upon actuated appendages, such as fins, interceptors or submerged foils, to counteract the rolling effects caused by waves and wakes. Fins, interceptors, and foils all depend on significant forward motion for their anti-roll forces, and are inefficient at low speeds. Prior gyroscope-related anti-rolling systems have either been too massive for relatively smaller vessels, such as yachts, or have been confined to use as a sensing system in combination with a structural element or elements that actually do the stabilizing. There is presently an unfilled need for an effective stabilization system deployable in boats and small ships, especially boats and small ships that are stationary or moving at low speeds.

An important aspect of providing suitable ship stabilization using a gyrostabilizer system, including the optional use of one or more additional stabilization components, is the control of the system. The control system is preferably capable of using any and all available control authority so as to bring about the desired change in the vessel's dynamic state. This control authority must control the gyrostabilization system or a combination of the gyrostabilization system with a number of other potential actuation systems or effectors. The control system should focus at least on the gyrostabilizer control portion for stabilization of the vessel's roll axis in particular. The control system further preferably uses measured values of key vessel state variables for use in the ascertaining the correct control commands.

Small ships with transom sterns and high-speed small craft can be equipped with trim tabs. Trim tabs are surfaces that are mounted flush with the hull at the transom, or are mounted in a recessed area slightly forward of the transom so that they can be flush with the hull when in a retracted position. Trim tabs are installed in pairs, mounted symmetrically on the port and starboard side. Trim tabs are single-sided effectors as the hydrodynamic forces created by the tabs are only on the lower surface. The upper surface is considered to be dry in either mounting configuration. The trim angle of trim tabs can be changed manually or dynamically. The trim angle of the port and starboard trim tabs are controlled separately, so that they can be used to correct for uneven port/starboard load conditions.

An individual trim tab can create a vertical force applied at the hydrodynamic center of the tab. The large offset of a trim tab from the center of gravity of the vessel allows the trim tab to create a significant bow-down moment and roll moment. The linear forces and yaw moment created by an individual trim tab are small and can be neglected for most purposes. By adjusting the trim angle of the individual trim tabs in response to control system commands, trim tabs can be used to create moments to counter pitch and roll moments created by waves and wakes. Trim tabs are highly effective in controlling quasi-static pitch and heel angles, and in controlling dynamic pitching motion. They are less effective in controlling roll motion because the roll moment arm for an individual tab is rather short. Trim tabs are only useful when the boat or ship is traveling at sufficient speed so as to create hydrodynamic lift forces on a tab.

Interceptors are flat plates affixed to the port and starboard transom of a boat or small craft. An interceptor creates a disturbance in the flow of water off of the transom, and that disturbance results in a vertical force that is applied to the hull bottom slightly forward of the interceptor. The amount of vertical force created by an interceptor is a function of the distance that the interceptor protrudes below the hull at the transom. The vertical force created by an interceptor is comparable to the force created by a trim tab. The forces and moments created by an individual interceptor are comparable to forces and moments created by trim tabs, and comments about the use and effectiveness of trim tabs apply to effectors as well.

### SUMMARY OF THE INVENTION

The present invention is a control system to utilize any and all available control authority so as to bring about the desired change in a vessel's dynamic state. This control authority is produced by the gyrostabilization system or a combination of the gyrostabilization system with a number of other potential actuation systems or effectors. The focus of the gyrostabilizer control portion is the control and stabilization of the vessel's roll axis in particular. The control system utilizes measured values of key vessel state variables for use in ascertaining the correct control commands.

As described in detail in the referenced applications, the gyrostabilizer includes a large mass (the rotor) nominally spinning about its maximum inertia axis. Initially, this may be coincident with the vessel's yaw axis. The spinning rotor is mounted on a gimbal mechanism so that the spin axis can be made to pitch towards either the positive or negative roll axis of the vessel. The rotor generates a large angular momentum vector about the spin axis. This momentum vector, when crossed (cross-product) with the pitch rate of the gimbal as well as the rotational rate vector of the vessel induces internal torques according to Equation (1) shown below:

$$[ \begin{matrix}{L}_{C} \\ {M}_{M} \\ {N}_{C} \end{matrix} ] = [ \begin{matrix}{qI}_{{R}_{z}} {ω}_{R} cos θ - {rI}_{{R}_{Y}} \dot{θ} \\ {rI}_{{R}_{z}} {ω}_{R} sin θ - {{pI}_{R}}_{z} {ω}_{R} cos θ \\ {pI}_{{R}_{Y}} \dot{θ} - {qI}_{{R}_{z}} {ω}_{R} sin θ\end{matrix} ] + [ \begin{matrix}{I}_{{R}_{z}} {ω}_{R} \dot{θ} cos θ \\ {I}_{{R}_{Y}} \ddot{θ} \\ - {I}_{{R}_{z}} {ω}_{R} \dot{θ} sin θ\end{matrix} ] \qquad ( 1 )$$

In (1), L_{C} and N_{C} are the torques in roll and yaw respectively that the gyrostabilizer imparts on the vessel and M_{M} is the total torque imparted on the pitch gimbal motor. The angle θ (and associated rate and acceleration \dot{θ}, \ddot{θ}) is the pitch angle of the gimbal/spinning rotor with respect to the vessel fixed frame, ω_{R} is the spin rate of the rotor and p,q and r are the angular rates of the vessel. Finally, the I_{R} (x,y and z) are the moments of inertia of the rotor measured about 3 orthogonal axes fixed in the body of the rotor.

In this application, the pitch motion of the gimbal and hence the rotor is controllable. The algorithms to be described herein are designed to process sensed motion (say, vessel attitude angles, angular rates p, q and r and pitch and pitch rate θ and \dot{θ} of the gimbal), compute appropriate control commands for the pitch gimbal and provide these commands to the pitch gimbal actuator so as to bring about the desired changes in the vessel's state. The first row of Equation (1) can be solved for the gimbal pitch rate (\dot{θ}) that produces the desired control torque in roll (L_{C}). This can be exploited in various control approaches.

The control system of the present invention, which may be considered to include the gyrostabilizer, accommodates the following modes of operations:

1. Gyrostabilizer Rotor Spin-up

2. Gyrostabilizer Rotor Spin-down

3. Vessel Parked—during this mode, control authority is available only from the gyrostabilization system. The nominal rate-damping control approach (discussed below) is active.

4. Low-Speed—during this mode, control authority is available from all resident systems. The nominal rate-damping control approach for the gyrostabilizer system (discussed below) is active.

5. High-Speed—during this mode, control authority is available from all resident systems. The nominal rate-damping control approach for the gyrostabilizer system (discussed below) is active.

6. Launching Events—during this mode, the control authority is available only from the gyrostabilization system. Additionally, attitude control as well as rate control is feasible during this phase since the vessel is not subjected to the trim torques present while the vessel is in the water.

### Low-Speed (Mode 4), and High Speed Operation (Mode 5)

Depending on the speed of a vessel relative to its size, the lift forces on the vessel can be created primarily by hydrostatic force, hydrodynamic forces, or a combination of the two. When a boat is at rest, it displaces an amount of water whose weight matches the weight of the loaded vessel. This results in a hydrostatic vertical force on the vessel that supports the vessel. Low operating speeds in which the hydrostatic forces dominate hydrodynamic forces are categorized as Displacement Mode of operation. As the vessel speed increases, hydrodynamic forces become significant. As a vessel starts to move, the flow of the water past its hull results in a reduction of force on the hull. As a result the vessel sinks into the water and its static trim angle changes slightly. The hydrodynamic center of pressure usually is forward of the hydrostatic center of pressure, so as its speed increases, the vessel begins to rise out of the water and its bow rises. This mode of operation is called Preplaning Mode. In displacement and preplaning modes, a vessel with a transom stern creates a wake that consists of both a diverging wave pattern and a transverse wake parallel to the transom. As the vessel speed increases further, hydrodynamic forces dominate hydrostatic forces. The vessel operates higher in the water than in displacement or preplaning modes, and as the speed increases the running trim angle of the vessel drops. This mode of High-Speed operation is called Planing Mode. The onset of planing operation can be defined in a number of ways, including the speed at which the trim angle reaches a peak, and the speed at which the transverse wake waves can no longer be sustained.

### Launching Events (Mode 6)

From time to time, a high-speed craft can operate in such a way as to launch off of a wave, becoming briefly airborne. If the relative heading of the vessel is perpendicular to the wave front, the vessel motion while airborne will be primarily in pitch and heave. If the vessel launches off a wave at an oblique angle, the interaction of the hull with the wave may impart a roll rate that is not countered while the vessel is airborne. This can result in the vessel landing at an undesirable roll angle.

When a vessel reenters the water after launching off a wave or wake, extreme hydrodynamic forces can be generated. Large magnitude forces are created when relatively flat sections of a hull impact the water at extremely high angles of attack. Vertical forces exceeding 10 G's have been measured on vessels, especially in forward sections.

Control surfaces based on hydrodynamics are ineffective during the time that a vessel is airborne. To control the impact forces of a vessel when it reenters the water, the control system driving the effectors must be able to predict launch forces and reentry attitudes, so as to apply appropriate corrective forces before the vessel leaves the water. This is extremely difficult, as it requires detailed knowledge of the waves or wakes forward of the vessel. A gyrostatic stabilizer or “gyrostabilizer” is a significant improvement over hydrodynamic effectors for controlling the dynamic attitude of a vessel during a launch incident. The gyrostabilizer can be used to apply roll moments to the vessel while it is airborne, assuring that the roll attitude will be acceptable when the vessel reenters the water. No other common effector can control the vessel both while it is in the water and when it is airborne.

### Control Concepts for a Decoupled Gyrostabilization System

The primary responsibilities of a control algorithm designed to utilize only the gyrostabilization system are:

1. Management of rotor spin rate

2. Determination of operating mode

3. Computation of roll acceleration commands to effectively counter the roll disturbance. When operating in modes 3-5 (above), the goal of the gyrostabilizer control is rate-damping. When operating in mode 6 (Launched), the goal is a combination of rate and attitude control.

4. Computation of associated gimbal pitch commands (this may be pitch rate commands or pitch acceleration commands depending on the specific servo) which will induce the desired roll acceleration.

In this context, the gyrostabilizer functions as a decoupled controller, functioning independently of other control surfaces and independently of pilot commands that may have been directed towards those other control surfaces.

The control system of the present invention, its features and advantages will become apparent upon review of the following detailed description, accompanying drawings and appended claims.

### BRIEF DESCRIPTION OF THE DRAWINGS

FIG. 1 is a simplified high level flow diagram for gyrostabilization control through the control system of the present invention.

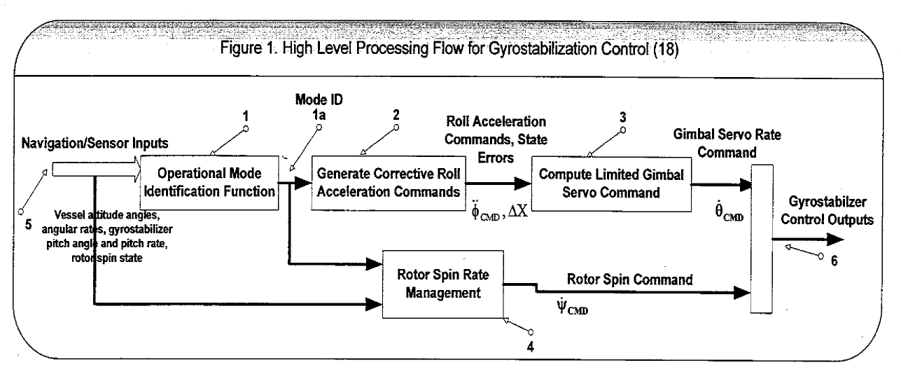

FIG. 2 is simplified flow diagram for rotor spin management of the gyrostabilizer through the control system.

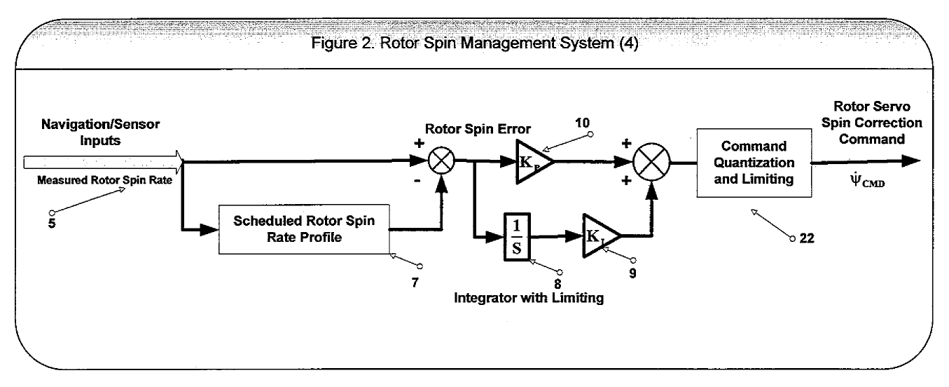

FIG. 3 is a simplified flow diagram representative of steps for generating corrective roll acceleration commands through the control system of the present invention.

FIG. 4 is a simplified flow diagram representative of steps for computing gimbal pitch servo commands through the control system of the present invention.

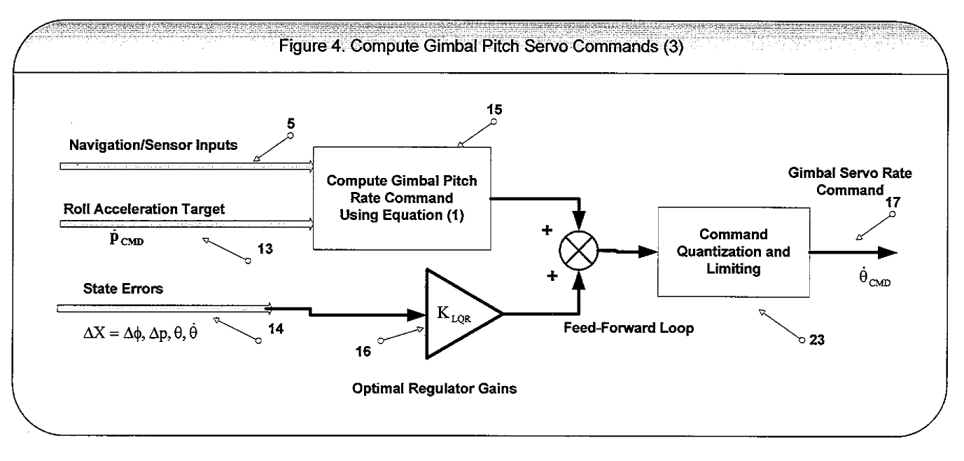

FIG. 5 is a simplified representation of features of the control system of the present invention for blended control of a plurality of stabilization control devices.

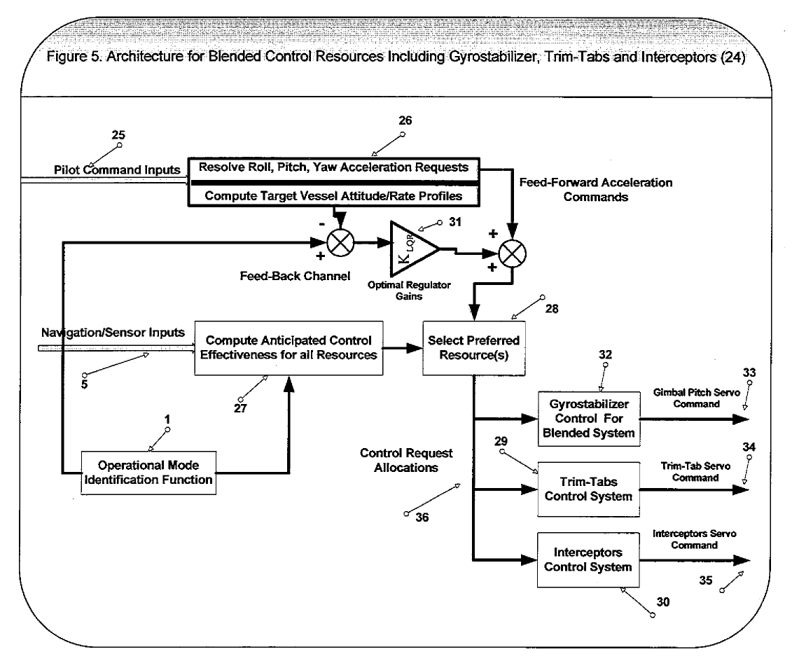

FIG. 6 is a simplified high level flow diagram for gyrostabilization control through the control system of the present invention for the blended control of a plurality of stabilization control devices.

FIG. 7 is a is a simplified flow diagram representative of steps for generating corrective roll acceleration commands through the control system of the present invention for the blended control of a plurality of stabilization control devices.

### DETAILED DESCRIPTION OF THE PREFERRED EMBODIMENT

A high-level process flow for the general control system architecture is shown in FIG. (1). A navigation function (described briefly below) is responsible for the processing of raw sensor data and producing measurements (or mathematically optimal estimates from a navigation filter) of key vessel states such as attitude angles, attitude (angular) rates and possibly velocity. Also, sensors on the gyrostabilizer system may provide feedback of sensed gimbal pitch angle and pitch rate as well as rotor spin rate.

### Basic Navigation/Sensor System Requirements

The goal of the navigation function is to provide the controller with all required state information. This may include (but not be limited to) vessel inertial attitude, angular (attitude) rates in roll, pitch and yaw, vehicle velocity vector, vehicle position vector and depth measurements. Also, sensors can be employed to provide feedback on the gyrostabilizer rotor rate, gimbal pitch angle, gimbal pitch rate and gimbal motor torque.

If multiple sources of sensed data, such as inertial measurement units (IMUs), including attitude gyros and accelerometers are used in conjunction with other sources of related data (such as GPS, depth gauges, altimeters, compasses, etc.) a navigation function may include a blending filter such as a Kalman Filter, but not limited thereto. This method can be used to provide the control software with optimal (blended) estimates of the critical vessel states.

### Operating Mode Identification Function (1)

This function utilizes navigation/sensor inputs (5) regarding the vessel state and determines the mode of operation as described above. The resulting mode indicator is then passed into the key control functions, which will alter the associated processing depending on this value.

### Computing Roll Acceleration Command (2)

The computation of the desired roll acceleration may be done in a variety of ways. One method is to treat the rolling vessel as a simple harmonic oscillator or pendulum, similar to the way an atmospheric vehicle oscillates about a stable trim point. The controller then is, in general, a roll rate damping system (11) rather than a roll angle correction system. This is because, as with an aircraft oscillating about a stable (trim) angle-of-attack, it is undesirable and potentially costly from a power consumption perspective to attempt to constantly correct the attitude error from trim. This is valid when the boat is in the water. In “Launch” mode only, attitude control is feasible since there is not a stable trim during this phase.

In the rate control sub-mode (“In-Water”, operating modes 3, 4 and 5), the goal is to optimally damp rates about the trim point. In the case of the rolling vessel the gyrostabilization control system should attempt to produce roll torques that strategically counter the roll rate errors. The target roll rate is zero, but only at the trim roll angle (φₜᵣᵢₘ≈0). Since the kinetic energy of such motion is maximum at the bottom of the pendulum swing (φ=0), it can be shown that the optimal point to apply control is also about this point. Hence a so-called Zone-of-Control is applied to constrain the region in which control occurs. This region can be described by a cone about the target roll angle (presumably φ_{targ}=0). The cone width is a user-preference setting with a larger cone resulting in more frequent control efforts and increased power consumption. If the preference is such, the cone width can be set to infinity so that control occurs regardless of the proximity to the trim roll angle.

Depending on the polarity and magnitude of the roll rate and roll angle, the corrective roll acceleration is determined. This can be computed in a number of ways, including a formulation, which accommodates the pendulum nature of the motion.

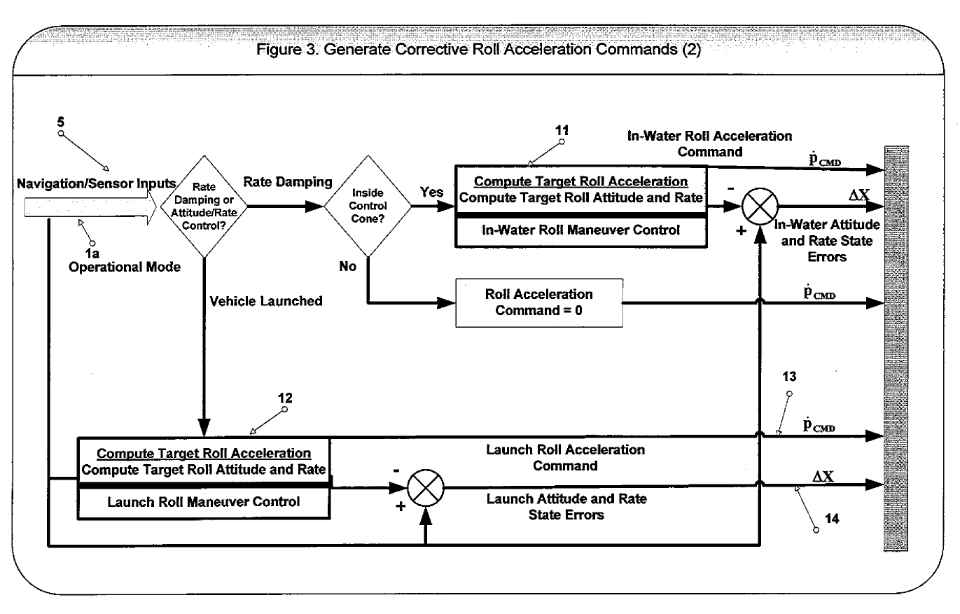

FIG. 3 shows an implementation of the Roll Acceleration Generator (2). The navigation data as well as the operational mode indicator are passed in as input. If the vehicle is in the water (not launch mode), the suggested method of control is rate damping using the Zone-of-Control cone. If the vehicle roll is inside this cone, a corresponding roll acceleration command is generated along with associated target states (roll angle, roll rate) (11). If outside the cone, the commanded roll acceleration is “0” and associated target states are computed.

If the mode indicator is “Launch Mode”, the objective is attitude/rate maneuver control (12). A maneuver profile is constructed that produces target angle, rate and acceleration commands at each control interval, based on the known initial and end conditions. This maneuver generation method can be accomplished using a number of techniques including numerical optimization methods such as Receding Horizon Control (Model Predictive Control) or a simple classical rate maneuver profile, with a ramp-up segment, a ramp-down segment and a coast segment in the middle, for example. Regardless, (In-Water or Launch), the target states are differenced with the measured states to produce an additional (feed-forward) state error signal (ΔX, 14). The commanded roll acceleration (13) as well as the feed-forward errors are then passed as output of this function.

### Computing Gimbal Pitch Rate Command (3)

The roll acceleration commands (\dot{p}_{CMD}, 13) as well as the state errors (deviations from the intended state trajectory, ΔX, 14) are passed to a function whose primary responsibility is the computation of the corresponding command to the gimbal pitch servo. Assuming for the moment that the selected servo requires a pitch rate command profile, FIG. (4) shows a candidate approach for the computation.

Using Equation (1) and any measured states from the navigation/sensing function and the roll acceleration command from the previous function required to appropriately respond to the roll disturbance, the corresponding gimbal pitch rate (17) is computed. This is the pitch rate of the gyrostabilizer that will induce the commanded vessel roll acceleration. Additionally, the state errors generated also by the roll acceleration function are converted to pitch servo rate command increments using proportional gains (16) computed, for example, using an optimal Linear Quadratic Regulator (LQR) formulation. The LQR method is well documented and available in common software development packages such as Matlab available from The MathWorks of Natick, Massachusetts. It provides well-established stability and performance characteristics and is convenient from a software development perspective. (Such applications require linearization of some components of the state dynamics, which would enable linear analysis techniques as well, if desired). Finally, the computed pitch rate for the gyrostabilizer can be pre-processed for quantization and limiting (18), prior to the signal being sent to the gimbal servo.

### Management of Rotor Spin Rate (4)

This function is primarily responsible for rotor spin-up, spin-down and rotor rate maintenance. The gyrostabilizer control system must consider the rotor momentum at all times, since this directly impacts the control authority available to correct the roll disturbances. A rotor spin-up/spin-down schedule (7), preset or computed as a function of required control authority, produces rate commands as input to the controller. Additionally, the actual spin rate of the rotor, measured by a sensor mounted in the gyrostabilizer, as well as the mode of operation (including whether in spin-up or spin down mode) provides feedback as to the current state of the system. FIG. (2) shows an example of a rotor management controller, with proportional (K_{P}, 10) and integral (K₁, 8,9) action. A standard PI or PID (with derivative action) is a typical method of driving, the rotor spin error to zero. The integrator (8) (limited to prevent saturation) can be used to capture and correct steady-state errors which are persistent in the system because of biases in the mechanism. The spin rate correction command for the gyrostabilizer is pre-processed for quantization and limiting (22), prior to the signal being sent to the rotor servo.

Control of Gyrostabilizer in Combination with Additional Control Effectors

The gyrostabilizer may be implemented in a blended control system that includes other means of control such as trim tabs, interceptors and anti-roll fins. FIG. (6) demonstrates such a system, inclusive of the gyrostabilizer, trim-tabs and interceptors. Pilot inputs are transferred to a Command Resolution/Target Attitude Profile function (26) for resolution into vessel-fixed roll, pitch and yaw acceleration commands and for generation of a target attitude profile. The commanded accelerations are fed-forward and combined with state errors, computed using the target profiles and measured states (5) to produce a feedback component. The combined acceleration command is now compared with the anticipated effectiveness of the available resources and a selection of the preferred resource(s) (28) is made. The output of this block (28) is a control resource allocation vector (36), with command requirements for each of the available control systems. This vector is distributed accordingly to the gyrostabilizer control (32), the trim-tab control (29) and the interceptor control (30) blocks.

### Command Resolution/Target Profile Generation (26)

The pilot commands must be resolved into vessel (or body-fixed) roll, pitch and yaw commands so that the total control request can be properly assigned to the various resources. This function is common in many aerospace and general stability augmentation problems. This function will produce an output acceleration vector (feed-forward) containing these resolved commands. Additionally, this function will compute a target attitude (Euler Angles) and attitude rate (roll, pitch and yaw) associated with the commanded accelerations. This attitude profile is differenced with the current measured vessel states (5) from the navigation/sensor system to produce the feedback state-errors. An optimal gain set, extracted from a gain scheduled look-up table and generated for example using LQR techniques, is applied to this error to produce the state-error feedback correction term. The feed-forward and feedback components are combined and the total commanded angular acceleration vector is passed to the Select Preferred Resource(s) function (28).

### Select Preferred Resource Function (28)

This function utilizes information regarding the potential control authority/effectiveness (27) available from each of the candidate control resources, given current vessel states, and vessel and control resource math models. An algorithm is employed to select the actuator(s), which most effectively and efficiently provide the needed response, according to the total commanded acceleration and the anticipated effectiveness of each available resource.

Various methods of control resource selection exist, such as those similar to the so-called “Jet Selection” logic used in numerous aerospace applications (including the NASA Space Shuttle). This method assesses potential control authority by computing the dot products between the desired torque vector and the torque vector to be provided by the candidate (i^{th}) control resource.

Hence, for iᵣₑₛ=1→N where “N” is the total number of available control resources, the (i^{th}) dot product is:

|T_{CMD}∥T_{CTRL}(i)|cos(φ(i))=\vec{T}_{CMD}·\vec{T}_{CTRL}(i)=Dot(i) (2)

In (2), T_{CMD} is the commanded/desired corrective torque, T_{CTRL}(i) is the available torque from the i^{th} control resource and φ is the angle between the two vectors.

The control resource blending process involves finding the maximum dot products that combine resources to obtain a sufficient and efficient corrective torque to satisfy the command. This is a straightforward method that performs well with multiple resources and requires relatively little software. Other approaches including prefabricated optimal look-up tables or the Simplex Method may also be applied to the blending problem.

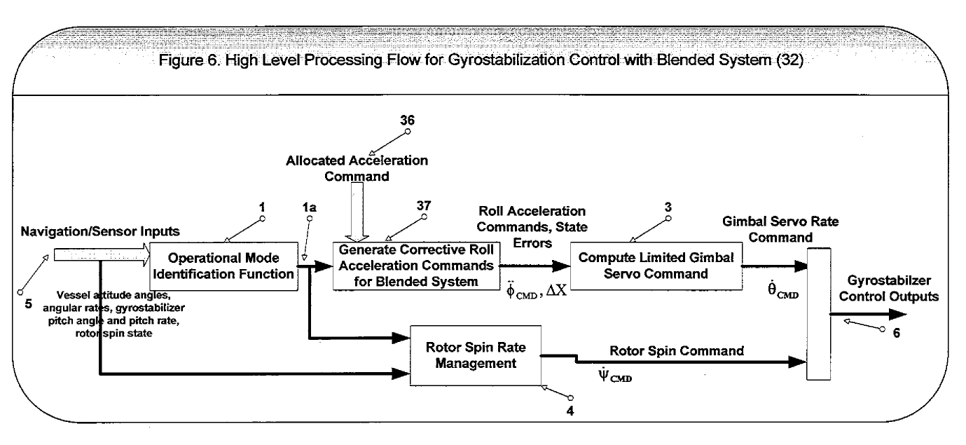

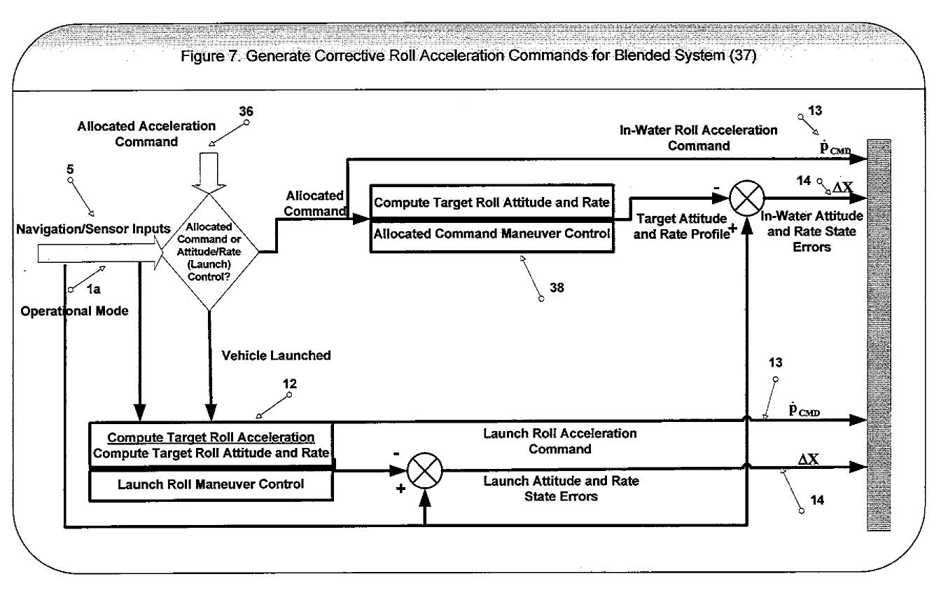

The control assignments (acceleration requests) allocated to the various resources are then passed to the individual control systems. Trim-tabs or interceptors primarily are capable of affecting pitch acceleration, and secondarily can be used to affect roll acceleration, On the other hand, the gyrostabilization system primarily is able to affect roll acceleration. The individual control systems will process the allocated commands according their respective control laws. The gyrostabilizer system produces primarily roll accelerations, as discussed above. In order to accommodate the blended environment, the gyrostabilization control system described above (18) is modified, specifically the “Computing Roll Acceleration Command” (2) function, resulting in the systems shown in FIGS. 6 and 7, the “Gyrostabilization Control with Blended System” (32) and “Generate Corrective Roll Acceleration Commands for Blended System (37)”.

### Generate Corrective Roll Acceleration Commands For Blended System (32).

This function, shown in FIG. (7), is similar to the function of FIG. (3) except that accommodations are made for the externally computed acceleration command from the control request allocations (36). In the event the vessel is in the water (modes 4 and 5), the acceleration command for the gyrostabilizer is generated by the selection function (28), rather than internally. As before, the “Allocated Command Maneuver Control” (38) computes the target attitude and angular rate profiles corresponding to the input acceleration command. The allocated acceleration command itself (13) is passed directly through in the feed-forward channel. The target profiles are differenced with the sensed vessel states (5) and the result is output as the “In Water” state errors (14).

In the event the vessel is in launch mode (mode 6), the identical processing to that of FIG. (3) occurs Acceleration commands and target attitude and rate profiles are computed. The acceleration command is passed through in the feed-forward channel (13) and the target states are differenced with the sensed states (5) to produce the state error (14).

The control system of the present invention may be described in the general context of computer-executable instructions, such as program modules, being executed by a computer. Generally, program modules include routines, programs, objects, components, data structures, etc. that perform particular tasks or implement particular abstract data types. The system of the present invention may also be practiced in distributed computing environments where tasks are performed by remote processing devices that are linked through a communications network or other data transmission medium. In a distributed computing environment, program function modules and other data may be located in both local and remote computer storage media including memory storage devices.

The computer processing device or devices and interactive drives, memory storage devices, databases and peripherals may be interconnected through one or more computer system buses. The system buses may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The computing device typically includes a variety of computer readable media Computer readable media can be any available media that can be accessed by a computing device and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computing device.

The computing system suitable for carrying out the computer-executable instructions may further include computer storage media in the form of volatile and/or non-volatile memory such as Read Only Memory (ROM) and Random Access memory (RAM). RAM typically contains data and/or program modules that are accessible to and/or operated on by the computer processing device. That is, RAM may include application programs, such as the functional modules of the system of the present invention, and information in the form of data. The computer system may also include other removable/non-removable, volatile/non-volatile computer storage and access media. For example, the computer system may include a hard disk drive to read from and/or write to non-removable, non-volatile magnetic media, a magnetic disk drive to read to and/or write from a removable, non-volatile magnetic disk, and an optical disk drive to read to and/or write from a removable, non-volatile optical disk, such as a CD-ROM or other optical media. Other removable/non-removable, volatile/non-volatile computer storage media that can be used in the computer system to perform the functional steps associated with the system and method of the present invention include, but are not limited to, magnetic tape cassettes, flash memory cards, digital versatile disks, digital video tape, solid state RAM, solid state ROM, and the like.

The drives and their associated computer storage media described above provide storage of computer readable instructions, data structures, program modules and other data for the computer processing device. A user may enter commands and information into the computer processing device through input devices such as a keyboard and a pointing device, such as a mouse, trackball or touch pad. These and other input devices are connected to the computer processing device through the system bus, or other bus structures, such as a parallel port, game port or a universal serial bus (USB), but is not limited thereto. A monitor or other type of display device is also connected to the computer processing device through the system bus or other bus arrangement. In addition to the monitor, the computer processing device may be connected to other peripheral output devices, such as printers.

The computer processing device may be configured and arranged to perform the functions and steps described herein embodied in computer instructions stored and accessed in any one or more of the manners described. The functions and steps, such as the functions and steps of the present invention described herein, individually or in combination, may be implemented as a computer program product tangibly as computer-readable signals on a computer-readable medium, such as any one or more of the computer-readable media described. Such computer program product may include computer-readable signals tangibly embodied on the computer-readable medium, where such signals define instructions, for example, as part of one or more programs that, as a result of being executed by the computer processing device, instruct the computer processing device to perform one or more processes or acts described herein, and/or various examples, variations and combinations thereof. Such instructions may be written in any of a plurality of programming languages, for example, XML, Java, Visual Basic, C, or C++, Fortran, Pascal, Eiffel, Basic, COBOL, and the like, or any of a variety of combinations thereof. The computer-readable medium on which such instructions are stored may reside on one or more of the components described above and may be distributed across one or more such components.

Alternatively, the control system of the present invention may be constructed from a combination of software and hardware or all hardware. Such hardware suitable for implementing the functions described herein include electronic components such as transistors, capacitors, resistors, operational amplifiers, comparators, and other components. These components can be used to implement functions such as addition, multiplication, integration, analog value comparison and most other mathematic and logical functions of the type required to carry out the capabilities of the control system of the present invention for the purpose of effective stabilization of a vessel. Other implementations of these control algorithms are possible using discrete components and by using integrated analog components.

One or more example embodiments to help illustrate the invention have been described. Nevertheless, it will be understood that various modifications may be made without departing from the spirit and scope of the invention. Accordingly, other embodiments are within the scope of the claims appended hereto.

What is claimed is:

1. A control system that converts sensor inputs to gyrostabilization control outputs comprising:
a. a block that utilizes sensed vessel attitude, and angular rates, the gyrostabilizer pitch rate and angle, and the rotor spin state, and identifies the operating mode of the vessel and its stabilizer;
b. a block that uses the operating mode of the vessel to compute the roll acceleration required to stabilize the vessel, wherein the block is a roll rate damping system;
c. a block that converts the roll acceleration commands and the vessel sensed attitude and angular rates to commands for the pitch gimbal servo system;

2. The control system of claim 1 with the addition of
a. a block that controls the rotor spin-up, spin-down and steady state rate;

3. The control system of claim 1 wherein the sensor input block includes a Kalman filter to blend inputs from multiple data sources such as inertial measurement units (IMUs), attitude gyros or accelerometers and other sources of related data such as GPS, depth gauges, altimeters, or compasses.

4. The control system of claim 1 wherein the block that computes the roll acceleration uses the operating mode of the vessel to select between a roll rate damping algorithm and a roll angle/rate correction algorithm. The roll angle/rate correction algorithm is selected when the vessel is airborne (launched). Otherwise the roll rate damping algorithm is selected.

5. The control system of claim 1 wherein the block that computes the roll acceleration such that the roll rate is optimized using a zone-of-control strategy whose objective is to damp the roll rate within a specified cone around the zero-roll midpoint.

6. The control system of claim 1 wherein if the vessel is airborne, the block that computes the roll acceleration
a. constructs a maneuver profile that produces target angle, rate and acceleration commands at each control interval based on the known initial and end conditions.
b. the target states are differenced with the measured states to produce an additional feed-forward state error signal. The commanded roll acceleration and the feed-forward errors are the output of this function.

7. The control system of claim 6 wherein the maneuver profile is constructed by using a rate maneuver profile with a ramp-up segment, a ramp-down segment and a coast segment in the middle.

8. The control system of claim 1 wherein the block that calculates commands for the gyrostabilizer pitch gimbal servo system
a. accepts roll acceleration commands and deviations from the intended state trajectory (state errors)
b. computes gimbal servo commands using the following equation:
$$[ \begin{matrix}{L}_{C} \\ {M}_{M} \\ {N}_{C} \end{matrix} ] = [ \begin{matrix}{qI}_{{R}_{z}} {ω}_{R} cos θ - {rI}_{{R}_{Y}} \dot{θ} \\ {rI}_{{R}_{z}} {ω}_{R} sin θ - {{pI}_{R}}_{z} {ω}_{R} cos θ \\ {pI}_{{R}_{Y}} \dot{θ} - {qI}_{{R}_{z}} {ω}_{R} sin θ\end{matrix} ] + [ \begin{matrix}{I}_{{R}_{z}} {ω}_{R} \dot{θ} cos θ \\ {I}_{{R}_{Y}} \ddot{θ} \\ - {I}_{{R}_{z}} {ω}_{R} \dot{θ} sin θ\end{matrix} ] \qquad ( 1 )$$

9. The control system of claim 8 wherein the state errors generated by the roll acceleration function are converted to pitch servo rate command increments using proportional gains computed by using an optimal Linear Quadratic Regulator (LQR) formulation.

10. A control system to manage the gyrostabilization rotor spin rate comprising:
a. a sensor to detect the rotor spin rate;
b. a proportional-integral controller (PI controller) that accepts spin rate sensor data and rotor spin-up, spin-down or steady state mode, and calculates an output for the rotor spin servo

11. The control system of claim 10 wherein the controller is a proportional-integral-derivative (PID) type.

12. A control system that converts sensor inputs to individual outputs for a gyrostabilization system and for trim tabs comprising:
a. a Command Resolution/Target Attitude Profile block that converts pilot inputs into vessel-fixed roll, pitch and yaw acceleration commands and generates a target attitude profile. The commanded accelerations are fed-forward and combined with state errors, computed using the target profiles and measured states to produce a feedback component.
b. a block that utilizes sensed vessel attitude, and angular rates, the gyrostabilizer pitch rate and angle, and the rotor spin state, and identifies the operating mode of the vessel and its stabilizer;
c. a block that uses the operating mode of the vessel to assess anticipated effectiveness of the control resources and whether launch mode is active
d. a function that compares the combined acceleration command with the anticipated effectiveness of the trim tabs and the gyrostabilizer. This function selects the preferred effector, and produces a control resource allocation vector with command requirements for the gyrostabilizer control and the trim-tab control.
e. a function to generate commands for the gyrostabilizer gimbals. If the vessel is in the water the function utilizes the control vector, derived from pilot inputs, produced in the previous step. If the vessel has launched out of the water, the function utilizes the same launch control method described in (4) above

13. The control system of claim 12 with the addition of
a. a block that controls the rotor spin-up, spin-down and steady state rate;

14. The control system of claim 12 with the trim tab effector replaced by an interceptor effector;

15. The control system of claim 13 with the trim tab effector replaced by an interceptor effector;

16. The control system of claim 12 with both trim tab effectors and interceptor effectors;

17. The control system of claim 13 with both trim tab effectors and interceptor effectors.
